(19) United States
(12) Patent Application Publication
(10) Pub. No.: US 2009/0172999 A1
(43) Pub. Date: Jul. 9, 2009

(54) Landscaping weed barrier and soil access device

(76) Inventor: Kendall P. Thorne, Layton, UT (US)

Correspondence Address: Kendall P. Thorne, 942 West 60 North, Layton, UT, 84041, US

(21) Appl. No.: 12/006,759

(22) Filed: Jan. 7, 2008

(51) Int. Cl. A01G 13/02

(52) U.S. Cl. 47/22.1; 47/32.3

(57) ABSTRACT

A weed inhibitor and weed barrier securing base having an aperture for earth working, and reusable aperture cover which may be removably affixed to the base. Anchors, removably affixed to the base, secure the base to both underlying soil and weed barrier. Further weed barrier securement is provided by additional short posts which protrude through the weed barrier from the base. When in place, the removable aperture cover inhibits plant growth in the area where the weed inhibitor is disposed as a useful weed inhibitor in areas not designated for plant growth. Removal of the aperture cover permits earth working and plant growth within the aperture.

### FIELD OF INVENTION

This device is related to weed inhibitors for garden plants, and especially for gardens which are further covered by weed barriers. The device is further related to devices which outline and protect definitive holes in weed barriers, thereby providing access to such holes for earth working and growing garden plants and bushes. The device is still further related to weed inhibitors having access apertures which, themselves, may be covered to selectively inhibit plant growth thereunder.

### PRIOR ART

Weed barriers have long been used to inhibit weed growth. Weed barriers are widely used in areas such as perennial gardens where earth working is rarely needed to stimulate new growth and above-ground vegetation is present all year round. Annual gardens, however, are benefited by earth working for planting new vegetation or introducing soil-enhancing nutrients. Furthermore, vegetation with limited growing periods leave exposed soil open to weeds during non-growing periods. Disturbing unsecured weed barriers may lead to fraying or tearing resulting in a compromised weed barrier and weed growth.

In the past, weed inhibitors have addressed issues related to perennial plant growth with emphasis on weed inhibition around a tree or shrub trunk. None include applying a reusable aperture cover to inhibit all plant growth or removing such a cover to permit plant growth as desired. Some known related art weed inhibitors include a number of U.S. patents related to protecting space around tree trunks. Examples of these are:

U.S. Pat. No. 7,160,054 to Gary LeRoy Smiley (Jan. 9, 2007) discloses a weed inhibitor which expands to accommodate the growth of tree or shrub trunks. Smiley (054) discloses covering the soil as the tree trunk expands; having a designed purpose is to prevent all weed growth around the trunk. U.S. Pat. No. 5,396,731 to Steve E. Byrne (Mar. 14, 1995) discloses a mulch pad with a central trunk receiving aperture and a partially pre-cut, relockable slit. U.S. Pat. No. 4,268,992 to Raymond J. Scharf, Sr. (May 26, 1981) discloses a tree protector with hollow, hold-down spikes for watering the tree.

U.S. Pat. No. 3,305,969 to Merle E. Mattson (Feb. 28, 1967) discloses a weed inhibitor mulch pad with a slit used to place the device around an existing tree or shrub. U.S. Pat. No. 6,276,869 to Kuniaki Yakushinji (Aug. 21, 2001) discloses a weed control plate formed conically to cover tree roots and ground. U.S. Pat. No. 6,705,044 to Francis C. Clancy (Mar. 16, 2004) discloses adjustable landscaping ergonomic pads of various shapes adapted for covering the soil around the trunks of shrubs, trees, and garden plants. U.S. Pat. No. 5,085,001 to Michael S. Crawley (Feb. 4, 1992) discloses a mulch skirt with serrations to custom-size the opening to fit a post or tree trunk. U.S. Pat. No. 5,522,176 to Gene C. Suttle (Jun. 4, 1996) A flexible landscaping ground cover to be placed around a base of an object, such as a tree or shrub, to prevent the vegetation growth with drainage holes which permit water and air to pass into the soil.

U.S. Pat. No. 4,308,688 to Thomas L. Revane (Jan. 5, 1982) discloses two or more fiberglass preformed sections interfit to form a cover about the base of a tree. Sections are removed as the tree grows. A framework is used as a concrete form to ensure the cover sections fit together properly. U.S. Pat. No. 4,648,203 to Michael Worzek (Mar. 10, 1987) discloses a protector for surrounding the base of a trunk of a tree with a barrier wall and outwardly extending flange which serves as a mower track. Pins anchor the device to the soil.

U.S. Pat. No. 5,323,557 to Donald J. Sonntag (Jun. 28, 1994) discloses a landscaping mat with a flexible inner portion with a concentric rib between inner and outer peripheries to retain ornamental landscaping materials. U.S. Pat. No. 3,896,586 to Edward Neal Caldwell (Jul. 29, 1975) discloses a system for promoting plant growth wherein a ground engaging member having a peripheral trough and depending root feeder elements is anchored in the ground and has a raised, apertured, central portion which overlies a plant, and wherein a cover member having a lower peripheral generally V-shaped trough is cooperatively received within the trough of the ground engaging member, the cover member also having a raised central shield portion providing protection for the plant as it protrudes upwardly through the central aperture in the ground engaging member during growth.

It may be noted that none of the above U.S. patents disclose or address problems related to annuals or planting in areas which may, from time to time, be vacated and in which it is desired, in those areas, to inhibit plant growth.

### BRIEF SUMMARY AND OBJECTS OF THE INVENTION

The present invention is a landscaping weed barrier securement device which may be constructed in varying sizes. This device secures plastic, fabric or other like membrane weed barrier around an open aperture in a plastic, fabric or other like membrane weed barrier. An aperture in the base of the device allows earth working while minimizing damage or disruption of the weed barrier. A reusable aperture cover allows closure of the base aperture to inhibit undesired plant growth. Conversely, the cover may be removed for access to the opening of the base aperture and allow plant growth. When applied, the reusable aperture cover and base create a light barrier and tortuous path to inhibit plant growth between the cover and base. Weed barrier securement posts secure the weed barrier to the base. Anchors disposed through the base secure the base and weed barrier to the soil.

The present invention helps maintain the integrity of the weed barrier by minimizing manipulation of the weed barrier whilst permitting vegetation growth when desired, or by means of the reusable aperture cover, the inhibiting same. Devices made according to the invention provide a means for maintaining weed barrier integrity whilst permitting earth working within the apertures of the weed barrier and base. Furthermore, the device provides a means for inhibiting weed growth with reusable aperture cover.

It is, therefore, the object of the invention to provide a device for securing a weed barrier, for providing a coverable aperture which may be exposed for earth working and plant growth.

It is another object to provide selective access through an orifice in the device to soil beneath the device for earth working.

Another object of the invention is to reduce or eliminate disturbance or damage to the weed barrier when planting or earth working through the orifice.

It is an important object of the invention is to inhibit vegetation growth by means of a removable and replaceable cover for the device aperture.

It is also an object of the invention to provide a tortuous path to inhibit vegetation growth between the reusable aperture cover and base.

It is yet another object to provide a tortuous path between anchors and anchor slots to inhibit vegetation growth between the base and anchors.

It Is still another object provide a manufacturing design by which parts may be made by injection molding, compression molding or vacuum molding.

It is another object to provide a device base which is secured to soil by plastic or metal anchors.

It is another object to provide multi-seasonal location for planting annuals year-to-year in order to maintain a consistent landscape design.

Another object of the invention is to prevent water from pooling on the base or aperture cover.

It is another object to provide a low-to-the-ground silhouette of the base such that the device is easily covered by mulch, bark, gravel or rock.

### BRIEF DESCRIPTION OF THE DRAWINGS

FIG. 1 is a perspective of a device made according to the present invention wherein a base of the device is disposed upon a weed barrier mat, an accessing aperture being disposed within bound of the device for access to soil and plants.

FIG. 2 is a perspective of the device seen in FIG. 1 removed from the weed barrier mat and associated soil.

FIG. 3 is a side elevation of the device seen in FIG. 2 with an aperture closing cover affixed to the device.

FIG. 4 is a perspective of the device and cover seen in FIG. 3.

FIG. 5 is a perspective of the inferior side of the device seen in FIG. 4.

FIG. 6 is a perspective of the cover seen in FIGS. 4 and 5.

FIG. 7 is a stake used to anchor the base of the device in soil.

FIG. 8 is a perspective of the inferior side of only the base of the device seen in FIG. 5.

### DETAILED DESCRIPTION OF THE ILLUSTRATED EMBODIMENTS

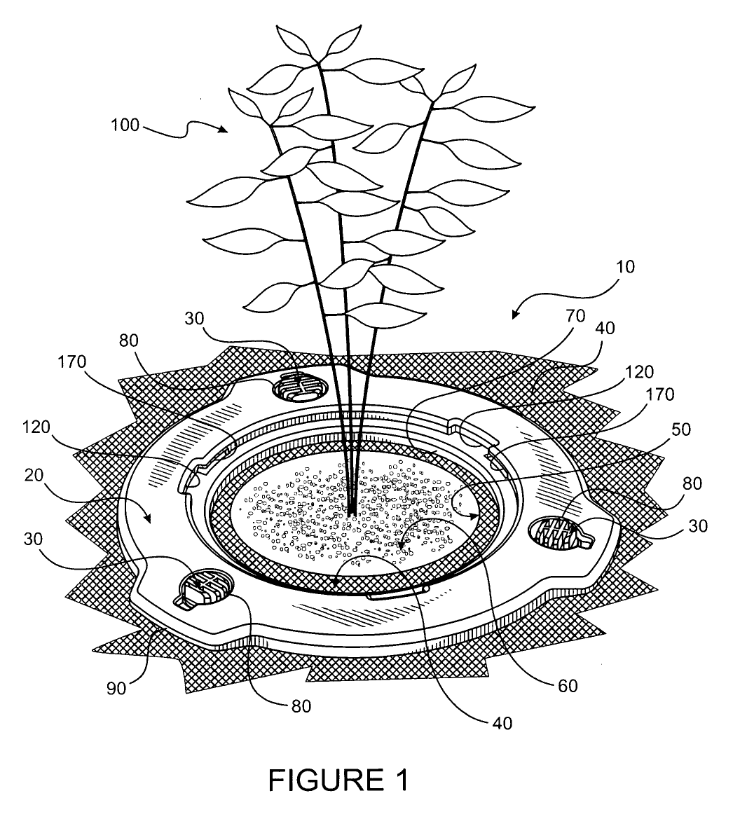

Reference is now made to the embodiments illustrated in FIGS. 1-8 wherein like numerals are used to designate like parts throughout. As seen in FIG. 1, a device 10 made according to the present invention comprises a base 20 which is generally securely affixed to underlying soil by one or more stakes or anchors, generally numbered 30. Conceptually, device 10 is disposed to cover and protect a portion of a ground cover mat, generally numbered 40. As is common practice in gardening, a hole, such as hole 50, is cut through mat 40 for access to soil 60.

Device 10 comprises an aperture 70 which surrounds hole 50 such that base 20 provides protection for mat 40 about hole 50. Though not necessary within the scope of the present invention, hole 50 and aperture 70 are preferred to be somewhat circular in construction. As seen in FIG. 1, such access to soil 60 permits controlled soil working and planting within hole 50 through aperture 70.

Further protection of mat 40 is afforded by securely affixing base 20 to soil 60 by stakes 30, each driven through an open stake aperture 80 in base 20, although, other ways of staking base 20 to soil 60 may be accomplished within the scope of the invention. For example, a “U” shaped stake may be affixed about an outwardly extending flange, such as flange 90. With a base 20 and hole 50 provided, a plant 100 may be planted and grown as seen in FIG. 1.

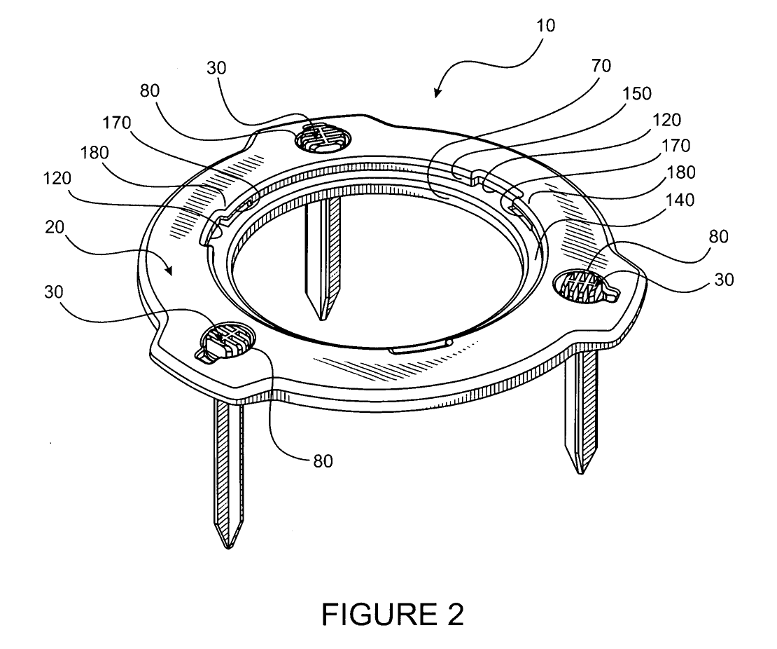

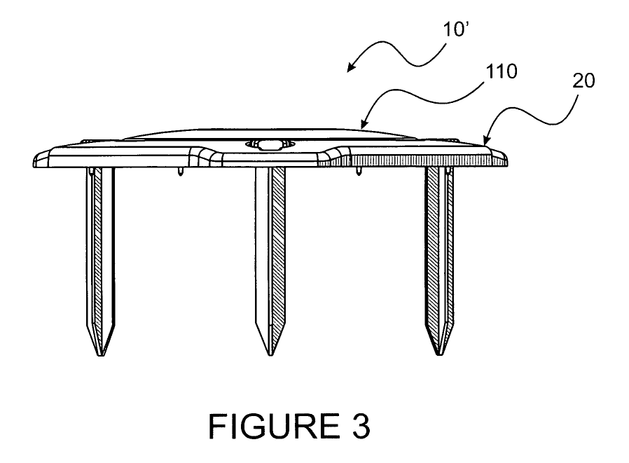

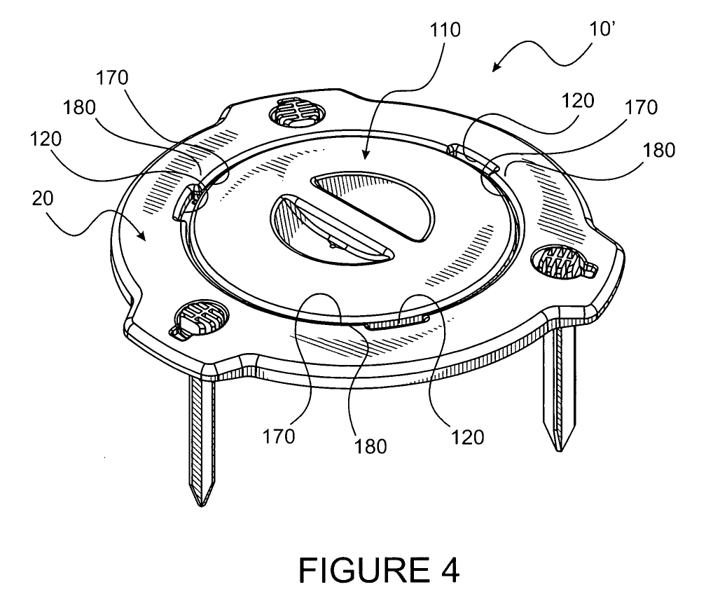

A clearer view of stakes 30 is seen in FIG. 2. While a single stake could be used to secure base 20, at least two stakes are preferred to assure securing base 20 about hole 50 (see FIG. 1). Reference is now made to FIGS. 3 and 4 wherein a cover 110 is seen affixed to base 20. to form a covered device 10′. As seen in FIG. 3, base 20 (and cover 110) form a low vertical silhouette which permits ground cover to readily cover either device 10 or device 10′.

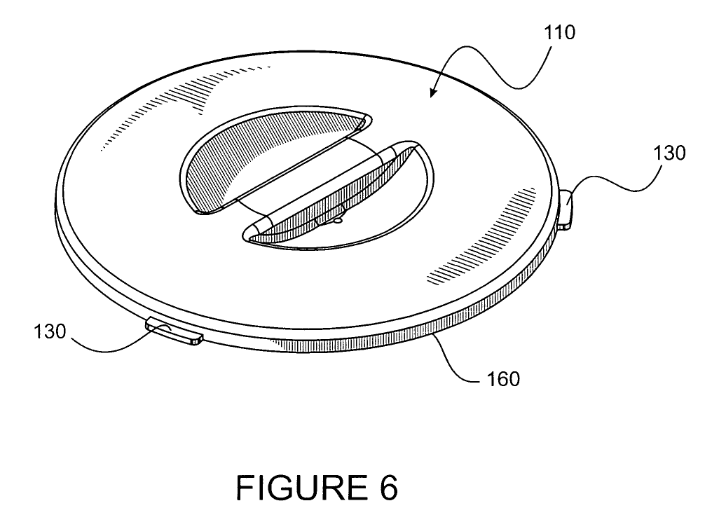

In FIG. 4, base 20 is seen to comprise a plurality of entry slots, each generally numbered 120, which accept a complimentary outwardly extending flange 130 of a cover, like cover 110 (better seen in FIG. 6). Further, as seen in FIG. 2, base 20 comprises an inner circular shelf 140 outwardly extending from aperture 70 to a raised inner ring surface 150.

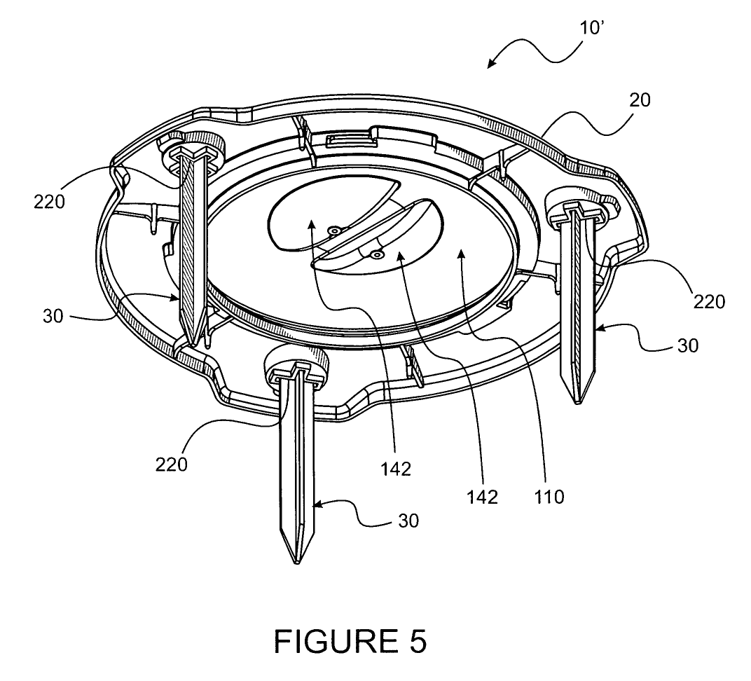

Cover 110 has an outer ring surface 160 which is complementary in size and width to surface 150 such that when cover 10 is disposed within surface 150 upon shelf 140, a circular tortuous pathway is defined from aperture 70 upward and outward to inhibit plant growth therethrough. As noted in FIG. 5, cover 110 comprises a pair of indentations 142 inbetween which a handle 144 is formed to permit cover 110 to be rotated to and from being latched to base 20.

Further, as seen in FIG. 4, base 20 has latching horizontal slots, each being generally numbered 170 (better seen in FIG. 2). The slots being disposed below an inner top part 180 of base 20 (better seen in FIG. 2) to provide a catch into which flange 130 of cover 110 (see FIG. 6) is rotated to securely, but releasable latch cover 110 to base 20 (as is also seen in FIG. 5).

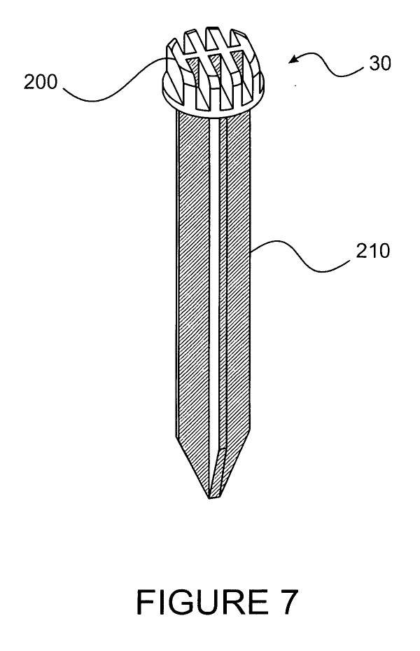

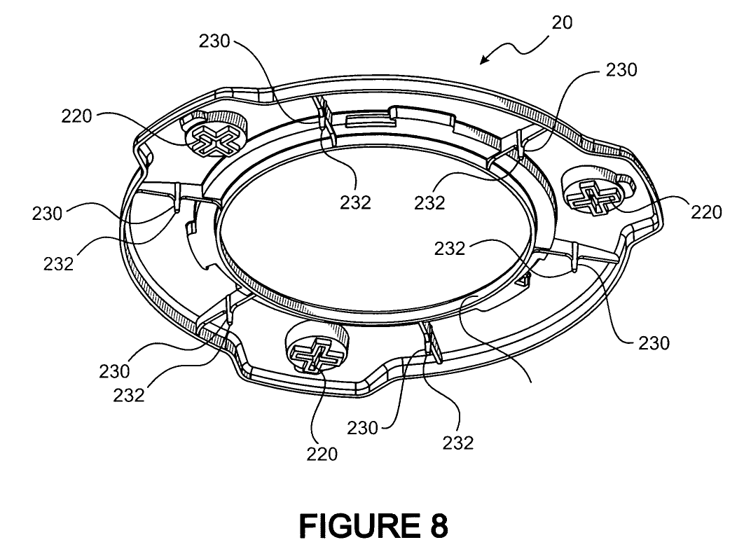

A stake 30 which is formed and in molded to be used with base 20 is seen in FIG. 7. Stake 30 comprises a head 200 which is formed to resiliently permit pounding into soil 60. Inferior extension 210 of stake 30 is formed to permit facile attachment to base 20 through complimentarily molded orifices, each numbered 220, see FIG. 8. A plurality of stakes 30 are seen disposed through orifices 220 is seen in FIG. 5. Stakes, which may be used with base 20, are currently available commercially.

As seen in FIGS. 5 and 8, base 20 further comprises a plurality of small, inferiorly descending sharp posts, each numbered 230. Each post 230 has a pointed end 232 which is sized and shaped to protrude through an associated mat 40 (see FIG. 1) and establish a secure holding geometry for mat 40 relative to base 20.

It is important that cover 110 be light inhibiting to reduce plant growth thereunder. Also, it is preferred that base 20 be similarly light inhibiting. It is therefore preferred that both cover 110 and base 20 be molded (e.g. injection molded) from synthetic resinous material which is weather resistant and substantially opaque. Such materials are widely available currently in the plastic molding art.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed and desired to be secured by Letters Patent is:

1. A device for protecting a ground covering mat about a hole therein made for earth working and for selectively permitting earth working and plant cultivating within the hole and, otherwise, selectively inhibiting plant growth within the holes, said device comprising:
a base comprising an aperture which is open about the hole, said base comprising at least one attachment site whereat a stake is driven to securely affix the base and the mat about the hole to the soil;
at least one stake for affixing the base and mat to the soil;
said base further comprising at least one latching site for a cover; and
the cover comprising at least one catch which is complimentary to said latching site whereby the cover is affixed to said base to close said aperture to inhibit plant growth there under and, otherwise, released and removed to permit access for earth working through said aperture and associated hole.

2. A device according to claim 1 wherein said aperture comprises a circular periphery.

3. A device according to claim 1 wherein said base comprises at least one sharpened post for anchoring the mat about the hole.

4. A device according to claim 1 wherein said cover comprises opaque material for inhibiting plant growth thereunder when said cover is affixed to said base.

5. A device according to claim 1 wherein said cover and said base in combination provide a tortuous path which inhibits plant growth when the cover is affixed to cover the aperture of the base.

6. A device according to claim 1 wherein said base is made of opaque material which inhibits light from passing therethrough.

7. A device according to claim 1 further comprising a sufficiently low silhouette for ground cover to be facilely disposed over the device and thereby hide the device from view.

8. A method for protecting edges of holes made in ground covering mats where through plants may be cultivated comprising the steps of;
(a) providing a device for protecting the ground covering mat about the hole made for earth working and for selectively permitting earth working and plant cultivating within the hole and, otherwise, selectively inhibiting plant growth within the holes, said device comprising:
a base comprising an aperture which is open about the hole, said base comprising at least one attachment site whereat a stake is driven to securely affix the base and the mat about the hole to the soil;
at least one stake for affixing the base and mat to the soil;
said base further comprising at least one latching site for a cover; and
the cover comprising at least one catch which is complimentary to said latching site whereby the cover is affixed to said base to close said aperture to inhibit plant growth thereunder and, otherwise, released and removed to permit access for earth working through said aperture and associated hole;
(b) disposing the base about a predetermined hole in the mat;
(c) driving at least one stake into the soil to affix the base about the hole; and
(d) releasibly affixing the cover to the base to inhibit plant growth through the hole.

9. A method according to claim 8 comprising the additional following additional steps:
(e) releasing the cover from the latch of the base; and
(f) selectively removing the cover from the base thereby providing access to soil through the aperture and hole.

10. A method according to claim 9 comprising the additional steps of:
(g) replacing the cover over the aperture; and
(h) affixing the cover to the base by latching the cover thereto.
